(19) United States
(12) Patent Application Publication
(10) Pub. No.: US 2004/0265085 A1
(43) Pub. Date: Dec. 30, 2004

(54) Cargo restraint device

(76) Inventors: Henry P. Mayer, Corona, CA (US); Lloyd Misner, Corona, CA (US)

Correspondence Address: James E. Brunton, 700 North Brand Blvd., Suite 860, P. O. Box 29000, Glendale, CA, 91203, US

(21) Appl. No.: 10/610,502

(22) Filed: Jun. 27, 2003

(51) Int. Cl. B60P 1/64

(52) U.S. Cl. 410/77

(57) ABSTRACT

A cargo carrier restraint device that is specially designed to permit faster and more expeditious loading of the last of a number of cargo pallets being loaded into the cargo bay of an airplane or like transport vehicle. In one form of the invention, the restraint device is movable angularly upward within the cargo bay upwardly in such manner as to provide substantial additional clearance for loading the last cargo pallet into the transport vehicle of on the order of one inch in the forward direction and on the order of one-half inch in the vertical direction. Following loading of the last pallet, the cargo restraint device can be moved angularly downward to a position wherein a device provides substantial forward and vertical restraint to the last to be loaded cargo pallets or containers. Movement of the cargo restraint device from the upward to the downward position is accomplished by a crank mechanism or, if desired, can be rotated by an electrical motor that can be conveniently operated from the exterior of the transport vehicle.

### BACKGROUND OF THE INVENTION

1. Field of the Invention

The present invention relates generally to cargo restraint devices for restraining pallets and containers within aircraft cargo bays. More particularly, the invention concerns a specially designed cargo restraint system which will permit faster and more expeditious loading of the last of a number of pallets being loaded into the aircraft cargo bay and will also provide substantial forward and vertical restraint to the final pallet that is loaded into the aircraft cargo bay.

2. Discussion of the Prior Art

The aircraft cargo handling industry uses several devices to facilitate the loading, unloading, and securing of palletized cargo within the aircraft cargo bays. One of these devices is an end restraint assembly, also known as a folding lock. These restraint assemblies, or folding locks, are secured to the floor of the cargo bay in strategically spaced apart rows. During the cargo loading operation, cargo pallets and universal loading devices are rolled over rollers provided in the floor of the aircraft cargo bay from the front of the bay to the back of the bay. As the first pallet moves rearward, a series of locks, such as the locking pawls located along the forward edge of the cargo bay are raised to stop the pallet from inadvertently moving forward of the cargo bay. However, when the locks are folded down or retracted, the cargo pallets can move freely over the restraint devices. In the upright position these locks or pawls exhibit a “T” profile so that when the next pallet is pushed back it will have these same locks along its aft edge, preventing movement of the pallet either upwardly or longitudinally of the cargo bay. The airplane is thus loaded in series fashion and unloaded in reverse.

The typical prior art end restraint consists of a base, two transverse shafts connected to the base, an inner and outer pawl rotatably connected to the shafts, torsion springs to urge the pawls into an upward position, and either pins or plungers to connect the assembly to tracks along the aircraft floor. The typical end restraint device operates by lifting the outer pawl to a vertical position. One of the torsion springs will then lift the inner pawl and snap both pawls into an upright position. The conventional prior art end restraint is collapsed by applying a downward force to the inner pawl. During normal cargo loading and unloading operations, the pawls are collapsed by the ground crew with foot pressure. The end restraint devices as described in the preceding paragraphs and the special pawl design embodied therein dates back to the middle 1960s and a number of different manufacturers currently manufacture and sell these types of devices.

One of the most successful prior art restraint systems ever developed is the system disclosed in U.S. Pat. No. 6,485,238 issued to B. Javier Segura and assigned to the assignee of the invention disclosed herein. U.S. Pat. No. 6,485,238 is incorporated by reference as though fully set forth herein. As will be more fully described in the paragraphs which follow, the system of the present invention comprises a significant improvement over the various prior art cargo container loading processes.

U.S. Pat No. 4,121,789 issued to Lent et al. discloses a cargo latch, particularly for securing pallets or containers within aircraft compartment of the kind comprising two pivotal latch arms movable between an operative position in which one arm engages an item of cargo to be secured and the collapsed position in which the item of cargo is freed.

U.S. Pat. No. 4,234,278 issued to Harshman et al. also discloses a locking device for securing air cargo units within aircraft cargo bay. The Harshman locking device comprises two pivotal latch arms of a relatively complex configuration only one of which is biased by spring means. The first pawl is held down in the retracted position by the weight of the second pawl. The outer locking pawl is generally “U” shaped in configuration having a pair of spaced apart legs and a foot shaped outer cross member for engaging the cargo carrier. The legs are pivotally mounted at their innermost extremities by means of pivot pins connected to the side members of the device base.

As will be understood from the discussion which follows, the apparatus of the present invention comprises a substantial improvement over the prior art and provides a novel “shunting lock” system that is specially designed to permit safer and easier loading of the last of several cargo pallets being loaded into the aircraft cargo bay.

By way of background, National Aerospace Standard NAS3610 specifies certain dimensions for the equipment used to retain palletized cargo and universal loading devices. This Standard specifies that the distance from the forward face of one lock to the aft face of the lock in front of it be such that a pallet disposed between them has 0.25-inch of longitudinal clearance. In certain models of airplanes every available inch of length is used to maximize capacity. This results in the last pallet that is loaded into the cargo bay having only a 0.25-inch of clearance forward and aft and only a 0.75-inch vertical clearance with respect to the adjacent restraint arms which must be in their upward position. This step of loading the last container into the cargo bay is, for obvious reasons, referred to by the loading crew as “threading the needle”.

The primary thrust of the present invention is to alleviate this troublesome “threading the needle” problem by providing a uniquely designed, “shunting lock” system that can be used to both simplify and expedite the loading of the last of several cargo pallets or containers into the aircraft cargo bay.

### SUMMARY OF THE INVENTION

It is an object of the present invention to provide a cargo carrier restraint device that is specially designed to permit faster and more expeditious loading of the last of a number of cargo pallets being loaded into the cargo bay of an airplane or like transport vehicle. More particularly, it is an object of the invention to provide a novel restraint device that is movable within the cargo bay angularly upwardly and downwardly in such manner as to provide substantial additional clearance for loading the last cargo pallet into the transport vehicle.

Another object of the invention is to provide a restraint device of the aforementioned character, which provides a clearance for positioning the last of several cargo pallets within the cargo bay of the transport vehicle of on the order of one inch in the forward direction and on the order of one half of an inch in the vertical direction.

Another object of the invention is to provide a restraint device of the type described in the preceding paragraphs which provides substantial forward and vertical restraint to the last of several cargo pallets or containers that are installed within the aircraft cargo bay.

Another object of the invention is to provide a restraint device of the class described which can be conveniently located near the main cargo door and which includes a restraining pawl that can be expeditiously folded into a location below the floor level of the cargo bay.

Another object of the invention is to provide a restraint device of the class described in the preceding paragraphs, which can be conveniently operated from the exterior of the aircraft.

Another object of the invention is to provide a restraint device as described in the preceding paragraphs, which is lightweight, compact, reliable in use and relatively simple and inexpensive to manufacture.

### BRIEF DESCRIPTION OF THE DRAWINGS

FIG. 1 is a generally perspective view of a prior art cargo restraint device.

FIG. 2 is a generally perspective, diagrammatic view illustrating the method of loading the cargo bay of an aircraft with cargo pallets or containers.

FIG. 3 is a side, fragmentary view looking into the cargo receiving opening in the aircraft cargo bay and showing the positioning of certain of the cargo restraint devices used to secure the cargo pallets in place.

FIG. 4 is enlarged side view of one of the end restraint devices of the apparatus of the present invention.

FIG. 5 is enlarged side view, similar to FIG. 4, but showing the carriage portion of the end restraint device moved into an upward position.

FIG. 6 is a cross-sectional view taken along lines 6-6 of FIG. 5.

FIG. 7 is a cross-sectional view taken along lines 7-7 of FIG. 6.

FIG. 8 is a view taken along lines 8-8 of FIG. 5, partly broken away to show internal construction.

FIGS. 9 and 10 when considered together comprise an enlarged top plan view of the central portion of the cargo bay

### DESCRIPTION OF THE INVENTION

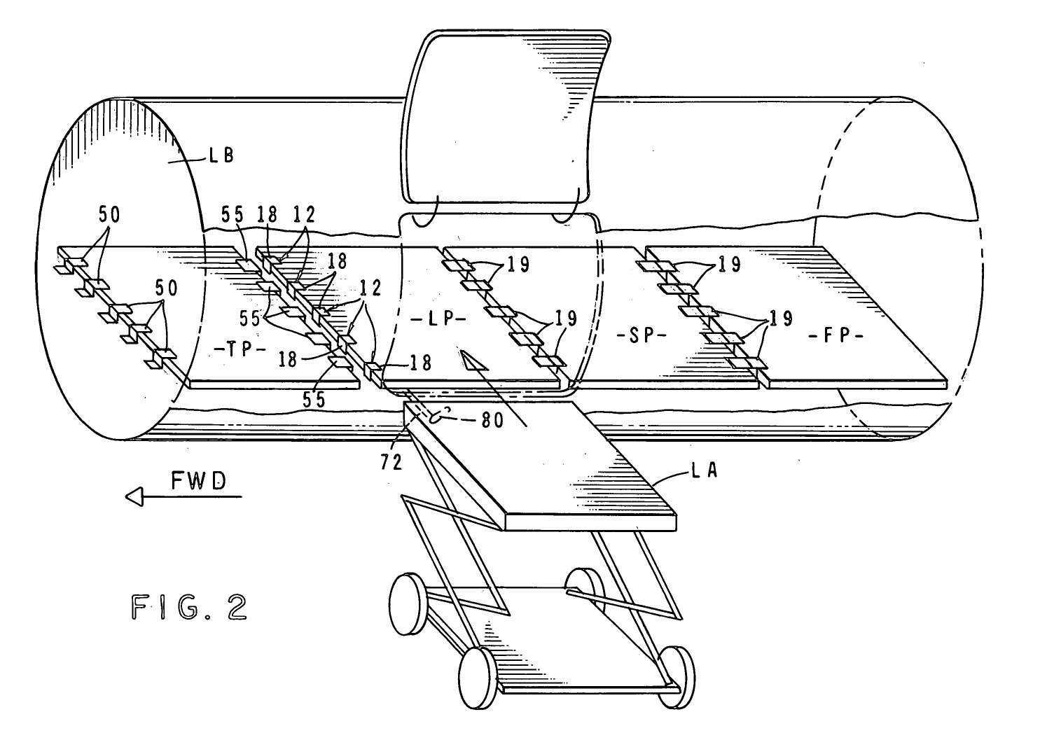

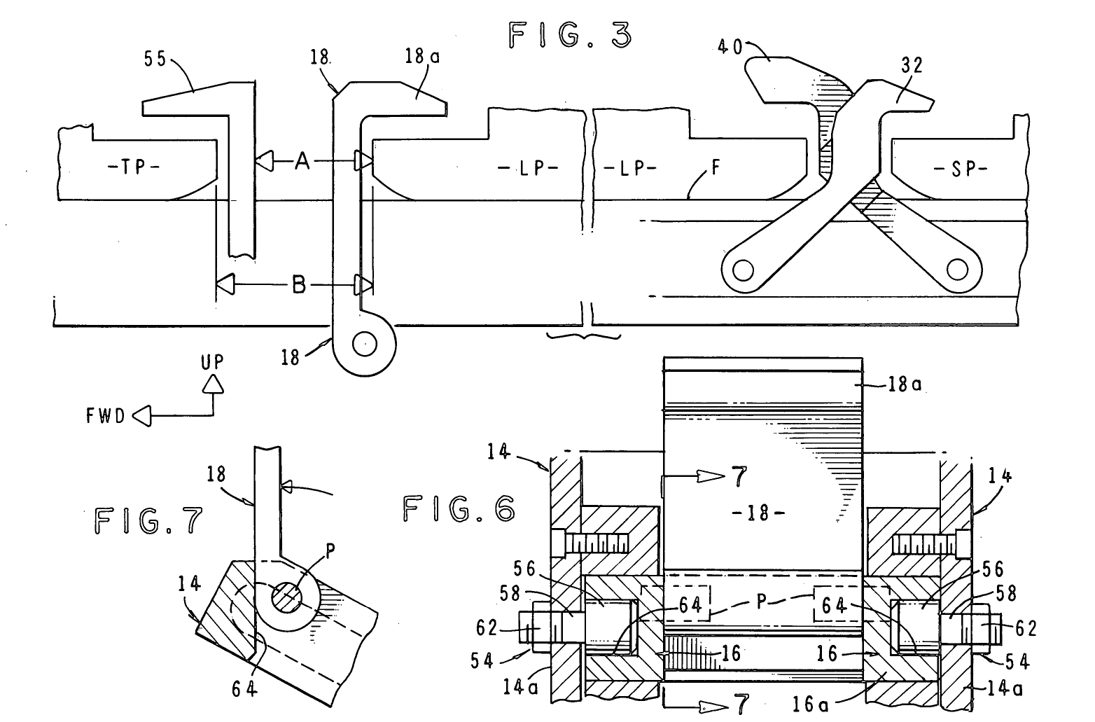

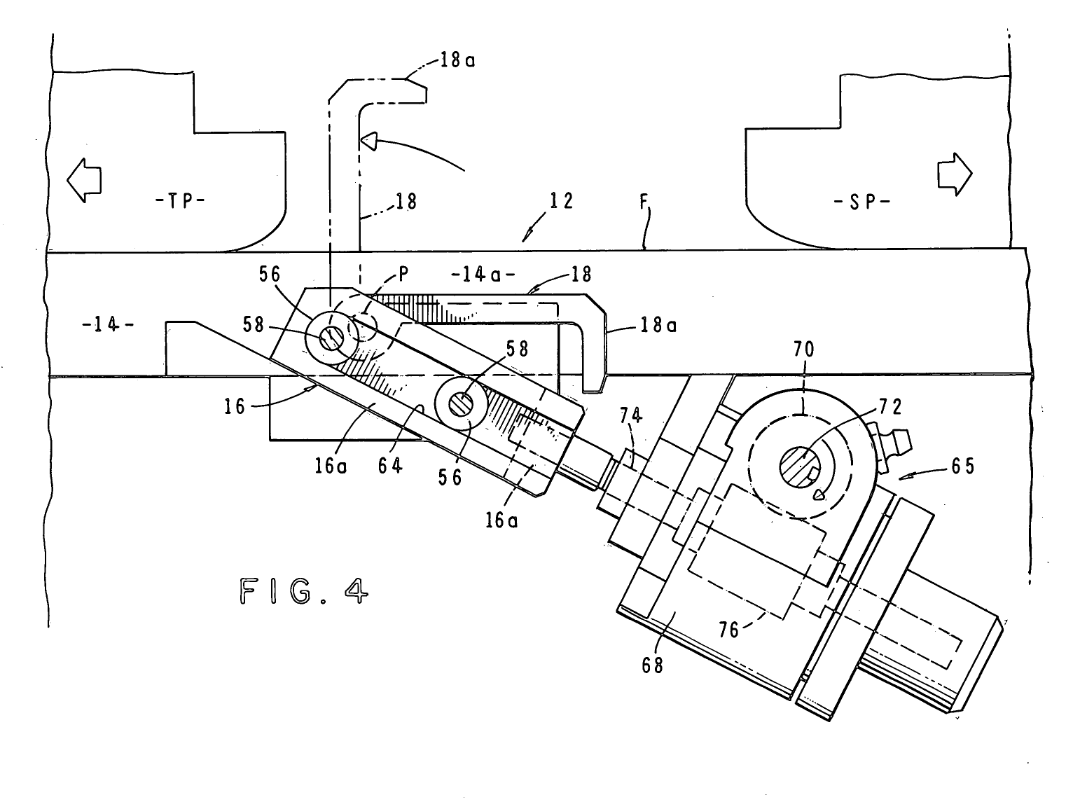

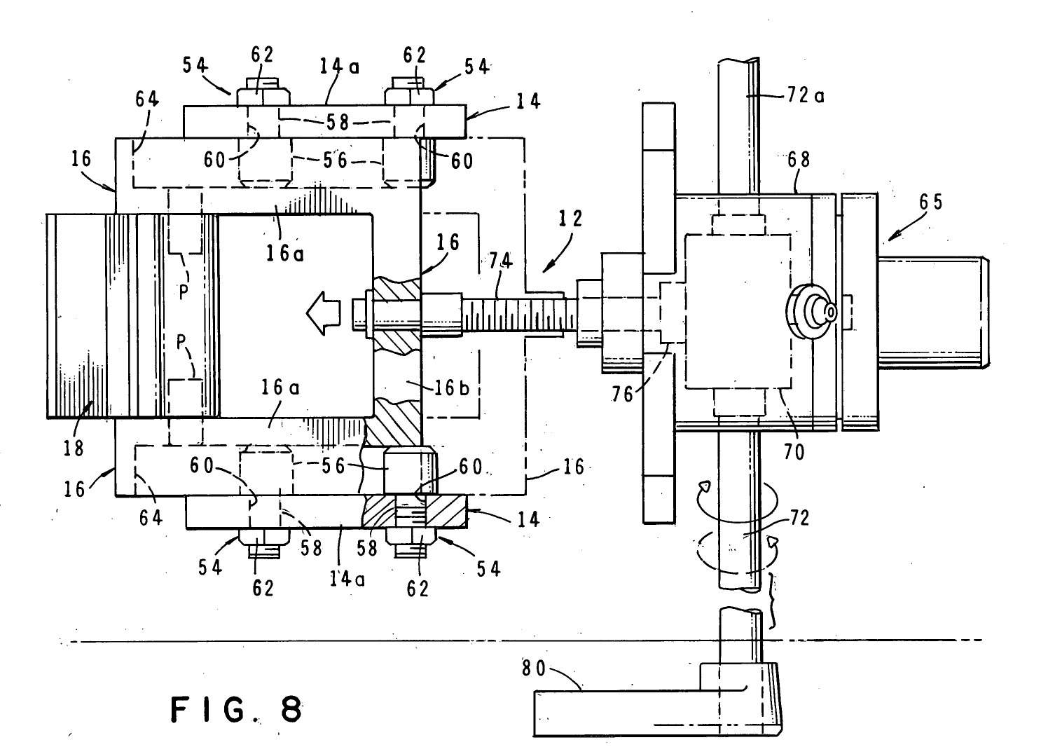

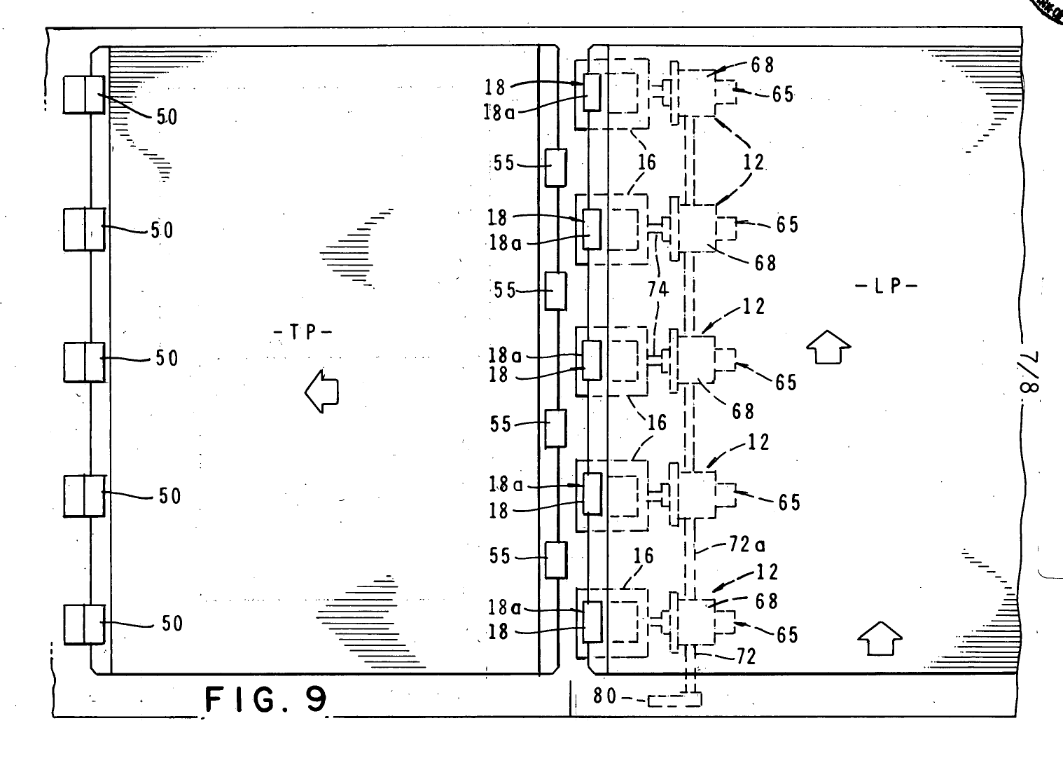

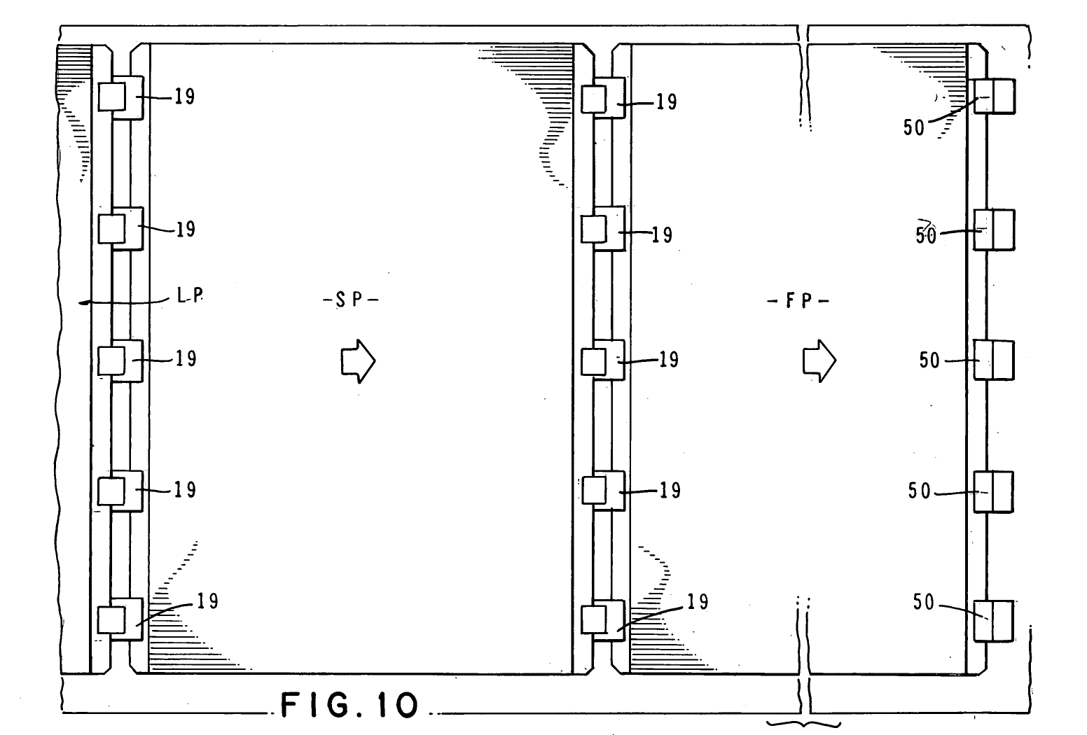

Referring to the drawings and particularly to FIGS. 4 through 8, one form of the end restraint device of the present invention is there shown. The end restraint device, which is shown in these figure drawings and generally designated by the numeral 12, is one of several substantially identical devices that are mounted within the aircraft cargo bay in a spaced apart relationship in the manner illustrated in FIGS. 2 and 9. In the present form of the invention the end restraint device comprises a support 14 which is mounted within the cargo bay (FIG. 8), a carriage 16, which is operably associated with support 14, a pawl 18, which is pivotally connected to carriage 16 for pivotal movement between a lowered position and an upstanding position and operating means for controllably moving the carriage between a first lowered position and a second elevated position. The details of construction of this end restraint device will presently be described.

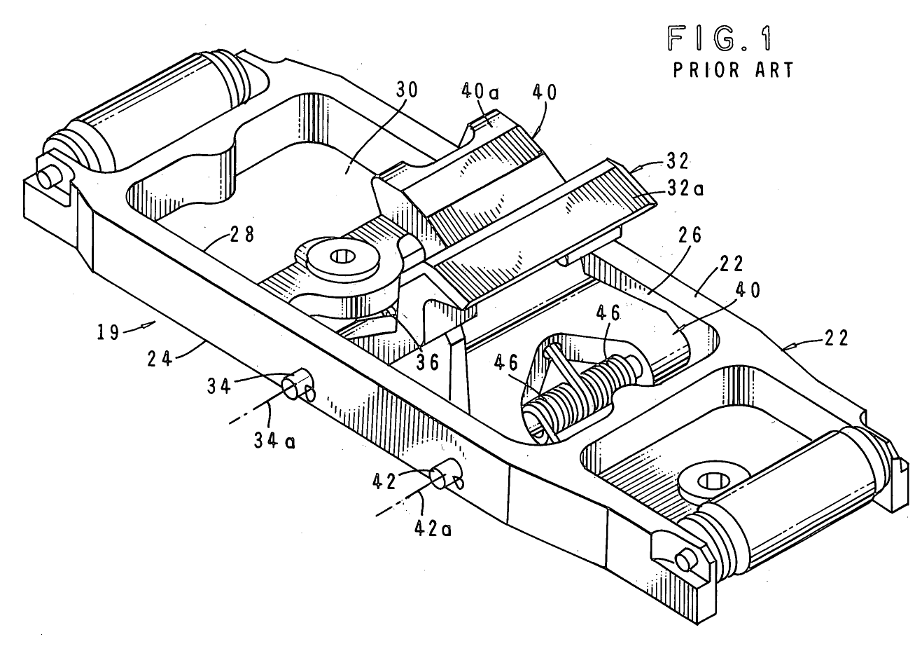

Also mounted within the aircraft cargo bay in a spaced-apart relationship are a plurality of conventional restraint devices, such as the restraint device illustrated in FIG. 1 of the drawings and a generally designated by the numeral 19. As shown in FIG. 1, these prior art restraint devices comprise a frame 20 having spaced-apart top and bottom walls 22 and 24 respectively. The frame also includes sidewalls 26 and 28, which cooperate to define a central opening 30. A first pawl 32 is pivotally connected to frame 20 for pivotal movement within central opening 30 about a first transverse shaft 34 having an axis 34a. A first biasing means shown here in the form of a torsion spring 36 functions to yieldably resist movement of first pawl 32 toward the upstanding position. A second pawl 40 is also pivotally movable within opening 30 about a second transverse shaft 42 having an axis 42a. Second pawl 40 is also movable between the lower position shown in FIG. 1 and the upstanding position. A second biasing means, here provided as a second torsion spring 46, functions to yieldably resist movement of the second pawl 40 toward the lower position of the pawl shown in FIG. 1. First pawl 32 is provided with a cargo flange engagement segment 32a and second pawl 40 is provided with a second flange engagement segment 40a for engaging the flanges of an air cargo container disposed within the cargo bay. During the cargo loading operation the first and second pawls are maintained in their lowered configuration so that the cargo pallets or containers can roll freely over the restraint devices. Only after the cargo pallets are in position within the aircraft cargo bay are the pawls moved into their upstanding securement position in the manner described in incorporated by reference U.S. Pat. No. 6,485,238.

During the cargo loading process, an example of which is illustrated in FIG. 2, when the first pallet, generally designated as“FP” is loaded into the cargo bay using the left apparatus “LA”, the restraint devices is are in their retracted configuration so that pallet “FP” can freely roll over the floor “F” of the cargo bay and over the retracted restraint devices. With the pallet “FP” in position, the restraint devices 19 shown in the right hand portion of FIG. 2 are raised bringing the aft facing pawls of the devices into a pallet securement position. Next, the second pallet, designated in FIG. 2 as “SP”, is loaded into the cargo bay and rolled over the retracted restraint devices 19 that are shown proximate the center of FIG. 2. As the second pallet is moved into position, the aft edge of the pallet will be received beneath the forward facing pawls of the restraint devices 19 that are shown in the right hand portion of FIG. 2. With the second pallet “SP” in position, the next to the last, or the third pallet “TP” is loaded into the cargo bay and moved toward the left bulkhead “LB” in the manner shown in FIG. 2. The forward edge of this pallet is closely received beneath the restraint arms of the upstanding pawls 50 of another type of single pawl, prior art restraint device, which is the character well known to those skilled in the art.

These restraint arms provide vertical and forward restraint for this forward most pallet only. With this next to the last pallet “TP” in position, the restraint arms of the upstanding pawls 55 of yet another type of single pawl, prior art restraint device, are raised to restrain the aft edge of the pallet “TP”. After loading of the next to the last pallet “TP” has been completed, the novel end restraint devices of the present invention are used, in a manner presently to be described, to accomplish the loading of the last pallet “LP”.

Turning once again to FIGS. 4 through 8, support 14 can be seen to comprise a pair of transversally spaced-apart walls 14a, each of which carries a pair of roller assemblies 54 (FIG. 8). Each of the roller assemblies comprises a roller 56 that is rotatably mounted on a shaft 58 which extends through an opening 60 formed in the walls 14a and is held in position by a nut 62. As indicated in FIG. 8, carriage 16 is generally U-shaped in configuration and has a pair of transversally spaced-apart sides 16a and a bight portion 16b that spans and is connected to the spaced-apart sides. As best seen in FIGS. 4 and 16, each side 16a is provided with an elongated track 64 within which rollers 56 are rollably received.

As indicated in FIGS. 4 and 8, the pawl 18 of each of the end restraint devices are pivotally connected to carriage 16 for pivotal movement about pivot pins “P” between the lowered position shown by the solid lines in FIG. 4 and an upstanding position shown by the phantom lines in FIG. 4. When the pawl is in its upstanding position, the upper, outwardly extending cargo container restraining segment 18a thereof is in close proximity with the edge of the last pallet “LP” to be loaded.

Forming an important aspect of the apparatus of the present invention is operating means which are mounted within the aircraft cargo bay and which are connected to the carriages of the restraint devices for controllably moving the carriages along with their pivotally connected pawls between a first lowered position and a second elevated position. In the present form of the invention the operating means comprises a plurality of spaced apart screw jack mechanisms 65 that are mounted within the aircraft cargo bay in the manner shown in FIG. 9 and are of the construction best seen in FIGS. 4, 5 and 8 of the drawings. Screw jack mechanisms 65 are of the character well understood by those skilled in the art and are readily commercially available from a number of sources including Nook Industries of Cleveland, Ohio. Detailed specifications and drawings of suitable mechanisms usable for present purposes are readily available from Nook Industries.

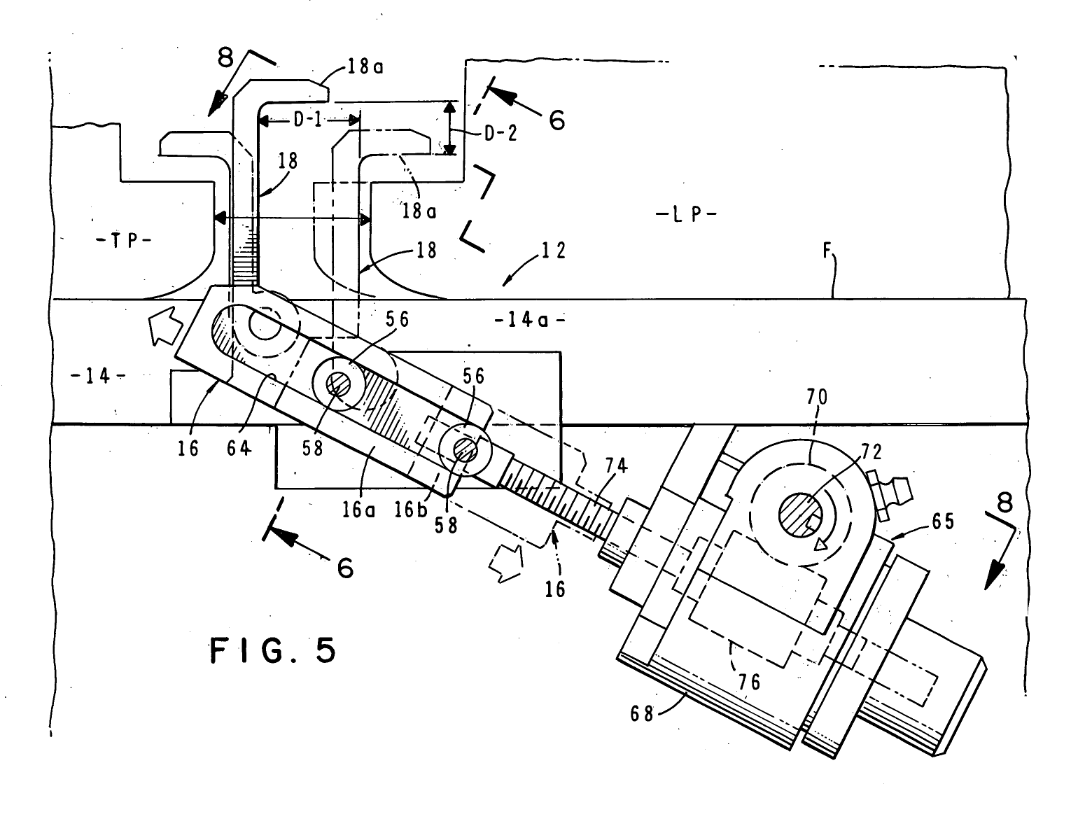

As shown in the drawings, each of the screw jack mechanisms 65 comprise a hollow housing 68, a drive gear 70 rotatably mounted within the hollow housing and a drive shaft 72 extending from the hollow housing for rotating the drive gear upon rotation of the drive shaft (FIG. 8). A driven shaft 74 is operably coupled with drive gear 70 by means of a worm gear 76 and is rotated thereby to move the driven shaft between a first retracted position shown in FIG. 4 and a second extended position shown in FIG. 5. As best seen in FIGS. 4, 5 and 8, driven shaft 74 is interconnected with the bight portion of carriage 16 so that as the driven gear 74 moves from a position shown in FIG. 4 to the position in shown in FIG. 5, carriage 16 along with pawl 18 will be moved angularly upward from the lower position shown in FIG. 4 to the upper position shown in FIG. 5.

After the last pallet “LP” is in position within the cargo bay in the manner shown in FIG. 5, rotation of the drive shaft in the opposite direction using the drive shaft rotation means of the invention will cause the carriage along with the pawl 18 to move into the securement position shown by the phantom lines in FIG. 5 to secure pallet “LP” in position within the cargo bay.

As illustrated in FIG. 6, the drive shaft rotation means is here provided in the form of a crank 80 which is accessible from the exterior of the cargo bay. It is to be understood that the drive shaft can be rotated by the hand crank 80, or, if desired, can be rotated by an electrical motor or by any other suitable mechanism of a character well known to those skilled in the art. As illustrated in FIG. 9 of the drawings, drive shaft 72 is operably coupled with the drive shaft 72a of the next adjacent screw jack mechanism 65 so as to simultaneously move the carriage of that adjacent mechanism angularly upwardly and downwardly. In a similar manner drive shaft 72a is operably coupled with the drive shafts of each of the adjacent jackscrew mechanisms so that all of the carriages and restraining pawls connected thereto move synchronously upon rotation of the drive shaft 72 by the drive shaft drive means, or crank 80.

As indicated in FIG. 5 of the drawings, when the carriages 16 and the pawls 18 of each of the securement devices of the invention are moved from the position shown by the phantom lines to the position shown by the solid lines, the pawl 18 will move forward by a distance D-1 and the pallet securement segment 18a will move upwardly by a distance D-2. When compared to the prior art cargo loading process, this movement of the pawls 18 provides substantial, additional lateral and a vertical clearance for loading the last pallet into the cargo bay. In the present form of the invention the distance D-1 is on the order of one inch and the distance D-2 is on the order of one-half inch thereby making the loading of the last pallet substantially easier, while at the same time providing a mechanism for adequately securing the last pallet within the aircraft cargo bay.

In order to satisfy the requirements of NAS361 0, once the last pallet “LP” is in position, the securement devices are shunted downwardly and aft into their final cargo container securement position as shown by the phantom lines in FIG. 5. This is accomplished by rotating crank 80 in the manner present previously described. If desired, the cranking system of the invention can be designed so that it can be conveniently folded into a location below the cargo bay floor level.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

We claim:

1. A restraint device for use in restraining a cargo container within an aircraft having an aircraft cargo bay having a floor and being provided with a cargo receiving opening, said restraint device comprising:
(a) a support mounted within said aircraft cargo bay proximate the cargo receiving opening;
(b) a carriage connected to said support, said carriage being movable relative to said support between a first lowered position and a second elevated position;
(c) a pawl pivotally connected to said carriage for pivotal movement between a lowered position and an upstanding position, said pawl having a leg provided with an upper, outwardly extending cargo container restraining segment; and
(d) operating means mounted within said cargo bay and connected to said carriage for controllably moving said carriage between said first lowered position and a second elevated position.

2. The restraint device as defined in claim 1 in which said carriage is provided with spaced-apart tracks and in which said restraint device comprises spaced-apart rollers connected to said support, said rollers being receivable within said spaced-apart tracks of said carriage.

3. The restraint device as defined in claim 1 in which said support is mounted within said aircraft cargo hold at an angle with respect to the floor of the aircraft cargo hold.

4. The restraint device as defined in claim 1 in which said operating means comprises a screw jack mechanism interconnected with said carriage for moving said carriage between said first lowered position and said second elevated position.

5. A restraint device for use in restraining a cargo container within an aircraft having an aircraft cargo bay having a floor and being provided with a cargo receiving opening, said restraint device comprising:
(a) a support mounted within said aircraft cargo bay proximate the cargo-receiving opening, said support extending angularly with respect to the floor of the cargo bay;
(b) a carriage connected to said support, said carriage having a pair of spaced-apart tracks and being movable relative to said support between a first lowered position and a second elevated position;
(c) a pair of rollers connected to said support, said rollers being rollably receivable within said pair of spaced apart tracks of said carriage;
(d) a pawl pivotally connected to said carriage for pivotal movement between a lowered position and an upstanding position, said pawl having a leg provided with an upper, outwardly extending cargo container restraining segment; and
(c) operating means mounted within said cargo bay and connected to said carriage for controllably moving said carriage between said first lowered position and a second elevated position, said operating means comprising a screw jack mechanism mounted within the cargo bay.

6. The restraint device as defined in claim 5 in which said screw jack mechanism comprises:
(a) a hollow housing;
(b) a drive gear rotatably mounted within said hollow housing;
(c) a drive shaft extending from said hollow housing, said drive shaft the being operably coupled with said drive gear for rotating said drive gear upon rotation of said drive shaft; and
(d) a driven shaft operably coupled with said drive gear and being rotated thereby to move said driven shaft between a first retracted position and a second extended position, said driven shaft being interconnected with said carriage.

7. The restraint device as defined in claim 5 in which said support comprises a pair of transversally spaced-apart walls and in which said carriage is receivable between said pair of spaced-apart walls.

8. The restraint device as defined in claim 1 in which said carriage is generally U-shaped in configuration and includes a pair of transversally spaced apart sides and a bight portion interconnecting said transversally spaced apart sides.

9. The restraint device as defined in claim 5 in which said screw jack mechanism is mounted within said cargo bay below the floor thereof.

10. A restraint device for use in restraining a cargo container within an aircraft having an aircraft cargo bay having a floor and being provided with a cargo receiving opening, said restraint device comprising:
(a) a support mounted within said aircraft cargo bay proximate the cargo receiving opening, said support having a pair of transversally spaced-apart walls and extending angularly with respect to the floor of the cargo bay;
(b) a carriage connected to said support, said carriage being generally U-shaped in configuration and having having a pair of transversally spaced apart sides and a bight portion connected to said spaced apart sides, each said side being provided with the track, said carriage being movable relative to said support between a first lowered position and a second elevated position;
(c) a pair of rollers connected to each of said transversally spaced-apart walls of said support, said rollers being rollably receivable within said tracks of said carriage;
(d) a pawl pivotally connected to said carriage for pivotal movement between a lowered position and an upstanding position, said pawl having a leg provided with an upper, outwardly extending cargo container restraining segment; and
(e) operating means mounted within said cargo bay and connected to said carriage for controllably moving said carriage between said first lowered position and a second elevated position, said operating means comprising a screw jack mechanism mounted within the cargo bay.

11. The restraint device as defined in claim 10 in which said screw jack mechanism comprises:
(a) a hollow housing;
(b) a drive gear rotatably mounted within said hollow housing;
(c) a drive shaft extending from said hollow housing, said drive shaft being operably coupled with said drive gear for rotating said drive gear upon rotation of said drive shaft;
(d) a driven shaft operably coupled with said drive gear and being rotated thereby to move said driven shaft between a first retracted position and a second extended position, said driven shaft being interconnected with said bight portion of said carriage; and
(e) means disposed externally of the cargo bay for rotating said drive shaft.

12. The restraint device as defined in claim 11 in which said means for rotating said drive shaft comprises a crank.
